(19) United States
(12) Patent Application Publication
(10) Pub. No.: US 2016/0062480 A1
(43) Pub. Date: Mar. 3, 2016

(54) INPUT DEVICE AND TOUCH PANEL DISPLAY SYSTEM

(71) Applicants: BENESSE CORPORATION, Okayama (JP); KOTO CO., LTD., Kyoto (JP)

(72) Inventors: Shuichiro OGAWA, Chofu-shi, Tokyo (JP); Satoshi KITAGAWA, Ota-ku, Tokyo (JP); Yoshihiro TAKI, Otsu-shi, Shiga (JP); Issei SUGA, Kyoto-shi, Kyoto (JP); Yoshitaka OGANE, Kyoto-shi, Kyoto (JP)

(21) Appl. No.: 14/786,544

(22) PCT Filed: Mar. 27, 2014
(86) PCT No.: PCT/JP2014/059005

§ 371 Date: Oct. 23, 2015

(30) Foreign Application Priority Data
Apr. 30, 2013 (JP) 2013-095636

(51) Int. Cl. G06F 3/033; G06F 3/044

(52) U.S. Cl. CPC G06F 3/033; G06F 3/044; G06F 2203/04106

(57) ABSTRACT

An input device with a plurality of terminals for inputting information in a touch panel includes three direction detecting contacts that are projecting portions to touch three positions on the touch panel and form a triangle having vertexes on the three positions, and at least one information identifying contact that touches the touch panel together with the three direction detecting contacts so that specific information to be displayed on a display panel is identified according to a placement position of the information identifying contact with respect to the triangle.

### TECHNICAL FIELD

The present invention relates to an input device for inputting information into a panel module including a touch panel and a display panel, and a touch panel display system utilizing the input device.

### BACKGROUND ART

As is well known, tablet terminals are widely used where an operator touches a screen of a panel module that includes a touch panel and a display panel with bare hands or objects, and the touch panel detects the touch, outputs coordinate information of the touch position, and outputs an image to the display panel of the panel module.

Further, in recent years, multi-type panel modules have been introduced for detecting multiple positions touched at the same time on a touch panel and outputting information. Specifically, panel modules for detecting a touch action of fingertips and performing a desired operation are also widely used.

Types of touch panels include, for example, a resistive film type for detecting voltage change by opposingly laminating metallic thin films having transparent electrodes, a surface acoustic wave type for detecting touch positions by generation of voltage of piezoelectric elements attached on a glass substrate, an inductive coupling type using an electronic pen, and an electrostatic capacitance type for detecting touch positions by a change in capacitance.

There is proposed, for example, an input device for manipulating and deforming an image displayed on a display panel at a touch position of a touch panel as an input device that detects a touch position on the touch panel of a panel module and displays an image on the display panel at the touch position on the touch panel (see Patent Literature 1).

Further, there is proposed a touch screen device having terminals for touching a touch panel on each surface (see Patent Literature 2).

### CITATION LIST

### Patent Literature

Patent Literature 1: JP2012-99093A

Patent Literature 2: JP2012-168612A

### SUMMARY OF INVENTION

### Technical Problem

Input devices having multiple terminals for touching a touch panel have limited patterns of arranging the terminals due to processing burden associated with identifying arrangement of the terminals, and thus it is difficult to increase types of input devices. Specifically, in a case where an input device is used for educational materials for children, the input device is formed in a size matched with hands of children. As such, the number of terminals to be disposed is limited, and it is difficult to provide enough types of input devices capable of fully demonstrating functions of the educational materials.

One or more embodiments of the present invention have been conceived in view of the above, and an object thereof is to provide an input device having a plurality of terminals that enable to input into a touch panel and a touch panel display system that efficiently identify the terminals.

### Solution to Problem

The technical problem is solved according to the present invention as described below.

An input device according to the present invention includes three direction detecting contacts that are projecting portions to simultaneously touch three positions on a touch panel and form a triangle having vertexes on the three positions, and at least one information identifying contact that touches the touch panel simultaneously with the three direction detecting contacts so that specific information to be displayed on a display panel is identified according to a placement position of the information identifying contact with respect to the triangle.

In the input device according to the present invention, the information identifying contact may be disposed in a rectangular area defined by two sides of the triangle, where the two sides interpose an internal angle of a first vertex of the triangle. In this case, the information identifying contact may be disposed in the rectangular area other than a position of the internal angle and a position of a vertex of an angle opposite to the internal angle. The triangle may be a right-angled triangle, and the first vertex may be a vertex of a right angle of the right-angled triangle.

In the input device according to the present invention, a direction of the triangle formed by the direction detecting contacts may determine a direction of the specific information to be displayed.

In the input device according to the present invention, an area in which the direction detecting contacts and the information identifying contact are disposed may be a substantially square area that has the three direction detecting contacts at respective corners, where a length of a side of the square area is 20 mm to 80 mm. In this case, a leg that does not react to a change in capacitance may be further provided at a corner of the substantially square area, where the corner is other than the corners at which the direction detecting contacts are disposed.

In the input device according to the present invention, each of the direction detecting contacts and the information identifying contact may be 5 mm or more in diameter, and the direction detecting contacts and the information identifying contact may be apart from one another by 6 mm or more.

Each of the direction detecting contacts and the information identifying contact may be selectively disposed in one of regions formed in a grid pattern in a rectangular area. In this case, the information identifying contact may be disposed in one of the regions other than the regions at four corners.

A touch panel display system according to the present invention includes a panel module formed by laminating a touch panel and a display panel, where the touch panel recognizes a detected touch position as coordinate information and the display panel displays an image on a screen, an input device including three direction detecting contacts that are projecting portions to simultaneously touch three positions on the touch panel and form a triangle having vertexes on the three positions, and at least one information identifying contact that touches the touch panel simultaneously with the three direction detecting contacts so that specific information to be displayed on the display panel is identified according to a placement of the information identifying contact with respect to the triangle. The touch panel display system also includes storing means for storing the specific information corresponding to a position of the information identifying contact with respect to the triangle, coordinate information obtaining means for obtaining coordinate information of a contact that touches the touch panel, calculation means for calculating three vertexes of the triangle based on the coordinate information obtained by the coordinate information obtaining means and specifying the direction detecting contacts and the information identifying contact, and display control means for extracting, from the storing means, the specific information corresponding to the information identifying contact specified by the calculation means and displaying the specific information on the display panel.

In the touch panel display system according to the present invention, in a case where coordinate information indicates that a fourth contact is positioned in a rectangular area defined by two sides interposing an internal angle of a first vertex of the triangle, the calculation means may specify the coordinate information of the fourth contact as the coordinate information of the information identifying contact.

In the touch panel display system according to the present invention, the display control means may control a direction of the specific information displayed on the display panel based on an inclination of the triangle with respect to the touch panel, the triangle being calculated by the calculation means.

In the touch panel display system according to the present invention, the triangle may be a right-angled triangle, and the first vertex may be a vertex of a right angle of the right-angled triangle.

A touch panel display system according to the present invention includes a panel module formed by laminating a touch panel and a display panel, where the touch panel recognizes a detected touch position as coordinate information and the display panel displays an image, and an input device including three direction detecting contacts that are projecting portions to simultaneously touch three positions on the touch panel and form a triangle having vertexes on the three positions, and at least one information identifying contact that touches the touch panel simultaneously with the three direction detecting contacts so that specific information to be displayed on the display panel is identified according to a placement of the information identifying contact with respect to the triangle. The touch panel display system also includes first storing means for storing lengths of two sides and an internal angle between the two sides that the triangle, second storing means for storing the specific information corresponding to a position of the information identifying contact with respect to the triangle, and coordinate information obtaining means for obtaining coordinate information of a contact that touches the touch panel. The touch panel display system also includes first calculation means for extracting three vertexes of the triangle based on the coordinate information obtained by the coordinate information obtaining means, calculating the two sides of the triangle and the internal angle between the two sides, and specifying, based on the two sides and the internal angle, the direction detecting contacts that form a predetermined triangle stored in the first storing means, and second calculation means for specifying, from the coordinate information obtaining means, coordinate information of a fourth contact that is disposed on a position other than the three vertexes of the triangle. The touch panel display system also includes determination means for determining whether the coordinate information of the fourth contact specified by the second calculation means is positioned in a rectangular area defined by the two sides interposing the internal angle calculated by the first calculation means and whether the coordinate information of the fourth contact is coordinate information indicating a position of a vertex of an angle opposite to the internal angle and, in a case where the coordinate information of the fourth contact is positioned in the rectangular area and does not indicate the position of the vertex of the angle opposite to the internal angle, specifying the coordinate information of the fourth contact as coordinate information indicating the position of the information identifying contact, and display control means for extracting, from the second storing means, the specific information corresponding to the information identifying contact specified by the determination means, and displaying the specific information on the display panel.

### Advantageous Effects of the Invention

According to the present invention, it is possible to provide an input device employing an arrangement pattern that enables to increase level of recognition of a touch panel and prevent an error recognition. As such, an input device suitable for educational materials for children and formed in a size for children to easily operate in one hand can be obtained.

### BRIEF DESCRIPTION OF DRAWINGS

FIG. 1 is a perspective view of an input device of embodiment 1.

FIG. 2 is a perspective view of an input device viewed from a bottom surface.

FIG. 3 is a side view of the input device placed on a panel module for explaining the input device shown in FIG. 1.

FIG. 4 is a bottom view of the input device shown in FIG. 1.

FIG. 5 is a bottom view of the input device.

FIG. 6 is a bottom view of the input device for explaining an arrangement pattern of educational materials for learning hiragana.

FIG. 7 is a bottom view of the input device for explaining an arrangement pattern of educational materials for learning hiragana.

FIG. 8 is a bottom view of the input device for explaining a variation of the embodiment 1.

FIG. 9 is a bottom view of the input device for explaining a variation of the embodiment 1.

FIG. 10 is a perspective view for explaining a touch panel display system.

FIG. 11 is a block diagram of the touch panel display system shown in FIG. 10.

FIG. 12 is a block diagram of an external memory shown in FIG. 11.

FIG. 13 is a flow chart of a program for operating the touch panel display system.

FIG. 14 is a bottom view of the input device for explaining an embodiment.

### DESCRIPTION OF EMBODIMENTS

An embodiment of the present invention will be described below with reference to the accompanying drawings.

### Embodiment 1

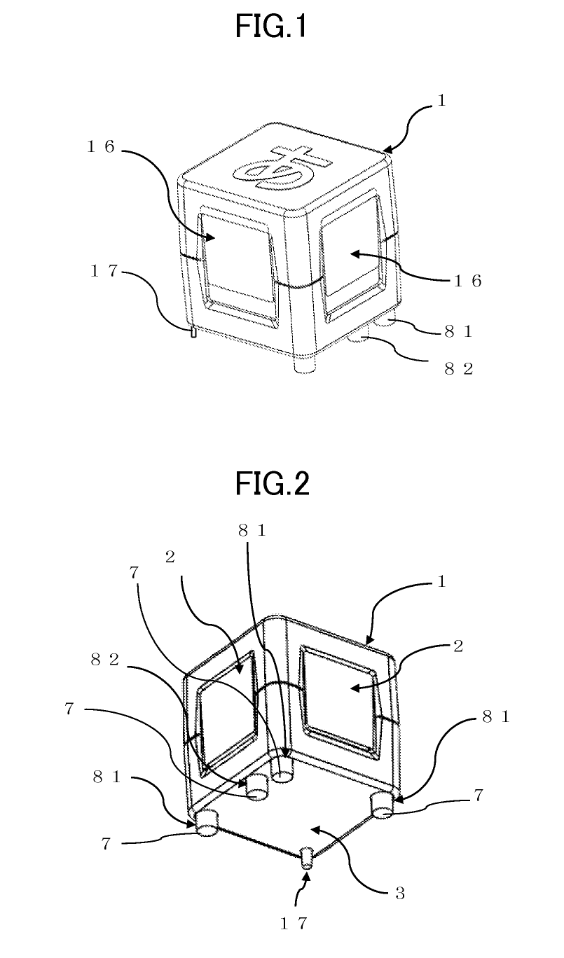

FIGS. 1 and 2 illustrate a dice-shaped input device 1 in a size that can easily be held in one hand of a child. Here, at least side surfaces 2 and a bottom surface 3 of the input device 1 have electrical conductivity. Holding the side surfaces 2 by hand produces static electricity in the input device 1, and the produced static electricity is transmitted to the bottom surface 3.

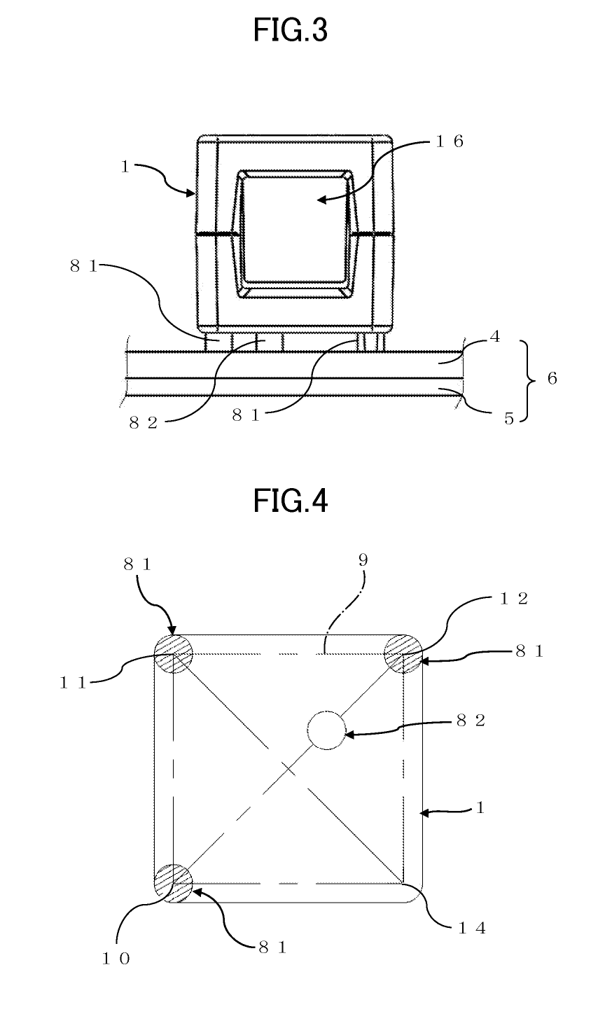

At least four projecting direction detecting contacts 81 and information identifying contacts 82 in total are disposed on the bottom surface 3 of the input device 1, where each of the projecting direction detecting contacts 81 and the information identifying contacts 82 includes a touch surface 7 that touches the panel module 6 formed by laminating the touch panel 4 and the display panel 5 (see FIG. 3). When the touch surfaces 7, which are charged with static electricity, of the direction detecting contacts 81 and the information identifying contacts 82 are in contact with the panel module 6, capacitance of the touch panel at the touch position is changed. The touch panel 4 recognizes such capacitance change as an input signal, and thereby specific information given to the input device 1 is displayed on the display panel 5 of the panel module 6.

As shown in FIG. 4, three direction detecting contacts 81 are respectively arranged on three vertex positions 10, 11, and 12 forming the right-angled triangle 9, and serve to detect an inclination of the triangle 9 to the touch panel 4. At least one information identifying contact 82 specifies specific information and is disposed at a desired position in a rectangle area formed with two sides interposing the right angle (position of the vertex 11) of the right-angled triangle 9 defined by positions on which the direction detecting contacts 81 are disposed. As shown in

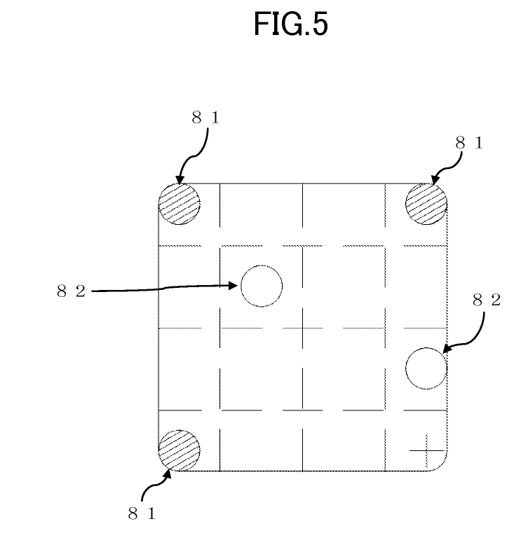

FIG. 5, each input device 1 is identified according to the positions on which the information identifying contacts 82 are disposed.

Further, the information identifying contact 82 is disposed at a desired position in the rectangle area other than the positions of the right angle (internal angle of the vertex 11) and the opposite right angle position (vertex) 14, where the rectangle area defined by the two sides interposing the right angle of the right-angled triangle 9. This enables to clearly detect the right-angled triangle 9 defined by the positions on which the direction detecting contacts 81 are disposed.

The input device 1 may be formed in a casing that includes a conductor and couples or integrates an upper part and a lower part, and have recesses 16 on four side surfaces for easier holding. A leg 17 that does not react to a change in capacitance and has the same length as the direction detecting contacts 81 and the information identifying contact 82 may be provided at the opposite right angle position (vertex) 14 for stable placement on the panel module 6. In this way, the input device 1 can be stably placed on the four corners, and the touch panel 4 can recognize only the direction detecting contacts 81 at the three corners.

The following will explain an arrangement pattern of an input device 1 capable of providing 71 consonants including 46 voiceless consonants and 25 voiced consonants in order to represent Japanese syllabary as an educational material for learning hiragana.

In order that an input device may be held and operated easily in one hand of children, including kindergarteners, a size of the input device is limited. Further, in a case of an educational material for learning Hiragana from “ [symbol] ” to “ [symbol] ”, at least 46 types of input devices for voiceless consonants, and 71 types of input devices when including voiced consonants are needed so that touch positions to touch a touch panel are different from one another. Previously, there has been no input device that satisfies these requirements. As such, conventional input devices have a problem in which the touch panel recognizes an input in error.

In view of this, the present inventors designed a large number of arrangement patterns on a limited surface and made prototypes by trial and error in order to satisfy the above described requirements and achieve an input device having high versatility as an educational material for children. The results of the trials showed that there are arrangement patterns that can increase level of recognition and prevent an error recognition on the touch panel even with small surfaces formed in a small size for children to easily operate in one hand. It is obvious that a size of an input device 1 that can be held by children in one hand is limited. As shown in FIG. 5, an arrangement pattern using vertical and horizontal 4×4 16 regions is beneficial to a pattern of arranging information identifying contacts 82 that can identify 71 types of information items and be placed on a small rectangular bottom surface 3 formed according to the limited size. According to this pattern, the information identifying contact 82 can use 12 regions other than 4 regions, which include 3 regions (positions of vertexes 10, 11, 12) used for the direction detecting contacts 81 and a region used for the opposite right angle position 14. When one or two information identifying contacts 82 are disposed, the number of arrangement patterns of the information identifying contacts 82 to use the regions can be selected from 78 patterns (12C1+12C2).

In a case of vertical and horizontal 3×3 9 regions, the arrangement pattern of the direction detecting contacts 81 and the information identifying contacts 82 cannot be achieved. In a case of vertical and horizontal 5×5 25 regions, the arrangement pattern can be achieved, however the direction detecting contacts 81 and the information identifying contact 82 get close to each other and may cause an error recognition. In a case of an input device that is large enough to prevent an error recognition, children are unable to easily operate in one hand. That is, considering a size that can be easily operated by children in one hand and an accuracy of the touch panel, arranging 1 or 2 contacts in 4×4 regions is most appropriate.

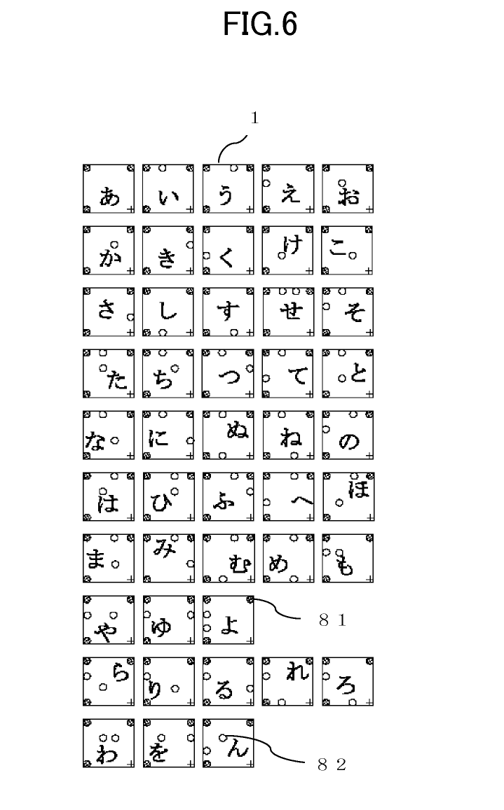

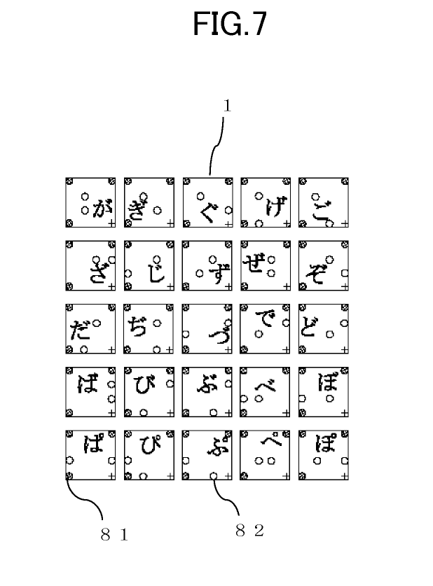

As shown in FIGS. 6 and 7, an input device 1 provided with information specific to “ [symbol] ” has only direction detecting contacts 81 on the bottom surface of the cube. Each of 12 input devices 1 respectively provided with information specific to “ [symbol] ” to “ [symbol] ” has an information identifying contact 82 in a different pattern. Each of 58 input devices 1 respectively provided with information specific to “ [symbol] ” to “ [symbol] ” has two information identifying contacts 82 in a different pattern.

When touch panels 4 respectively recognize information identifying contacts 82, these input devices 1 display hiragana character images from “ [symbol] ” shown in FIG. 6 to “ [symbol] ” shown in FIG. 7, and simultaneously, play various sounds from speakers as if stamps are pressed.

In this embodiment, direction detecting contacts 81 of an input device are placed at three vertex positions forming a right-angled triangle, and thus a direction of the input device 1 placed on a touch panel 4 can be detected, and a display direction of specific information provided to the information identifying contact 82 can be easily specified.

In addition, one or two information identifying contacts 82 are disposed in a rectangle area defined by two sides interposing a right angle of a right-angled triangle therebetween. As such, even when a child holds and puts an input device 1 on a touch panel 4 and his/her fingers touch the touch panel 4 in error, it is possible to prevent an error recognition because a position indicated by coordinate information of the finger touch is located outside the rectangle area.

Further, the information identifying contacts 82 are disposed at desired positions in the rectangle area other than the right angle and the opposite angle vertex positions, and thus the direction detecting contacts 81 of the input device are easily specified.

In the embodiment described above, each input device is assigned with a hiragana, but may be assigned with a character such as katakana, kanji, alphabet, number, and symbol, or color and mark. In addition, not only a single character but also a word or a sentence may be assigned.

### [Variation 1]

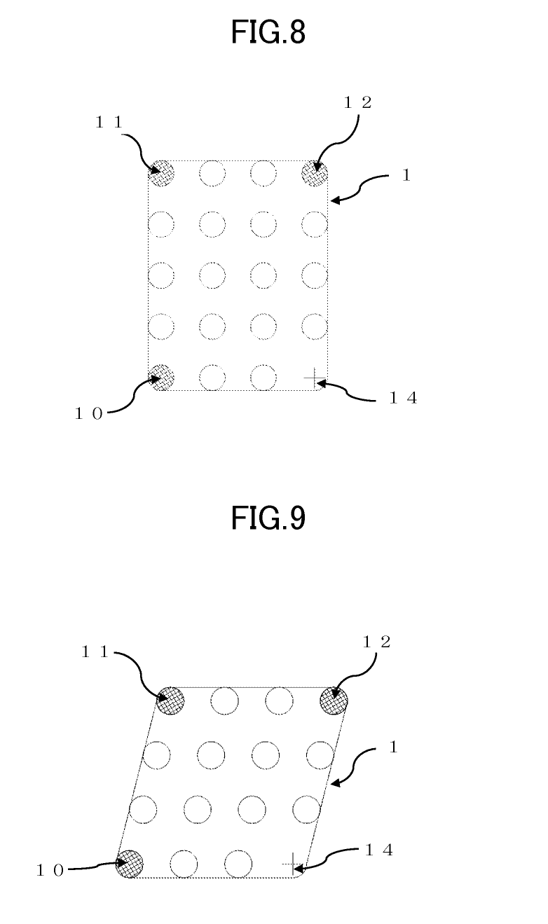

An input device 1 shown in FIG. 8 is variation 1 of the embodiment 1. In FIG. 8, numerals same as in FIGS. 1 to 7 indicate the same or corresponding parts, and show an arrangement pattern of direction detecting contacts 81 and information identifying contacts 82.

In this variation, the input device 1 is block-shaped, has a rectangular bottom surface 3, and employs a pattern of arranging direction detecting contacts 81 and information identifying contacts 82 in vertical and horizontal 5×4 20 regions. In this input device 1, information identifying contacts 82 can be disposed in 16 regions other than 4 regions, which include 3 regions (positions of vertexes 10, 11, 12) used by direction detecting contacts 81 and a region used by the opposite right angle position 14.

### [Variation 2]

An input device 1 shown in FIG. 9 is variation 2 of the embodiment 1. In FIG. 9, numerals same as in FIGS. 1 to 7 indicate the same or corresponding parts, and direction detecting contacts 81 and information identifying contacts 82 are disposed in a rectangular area of a parallelogram defined by predetermined triangles each having two sides interposing the largest internal angle therebetween.

In a case where the input device 1 is placed on the panel module 6 constituting the display panel 5 and the touch panel 4 where the display panel 5 is laminated on the top of the panel module 6, the direction detecting contacts 81 and the information identifying contacts 82 of the input device 1 do not directly contact but get close to the touch panel 4. This state is also described as “touch.” Accordingly, to touch also includes to get close to.

### Embodiment 2

The touch panel display system including the input device 1 and the tablet terminal 18 according to the embodiment 1 will be discussed with reference to the drawings.

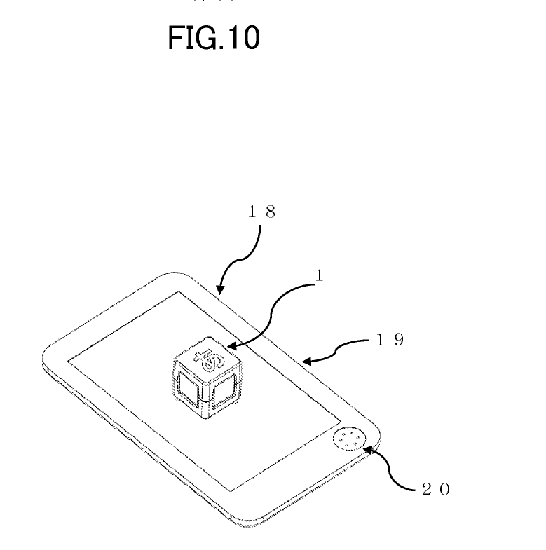

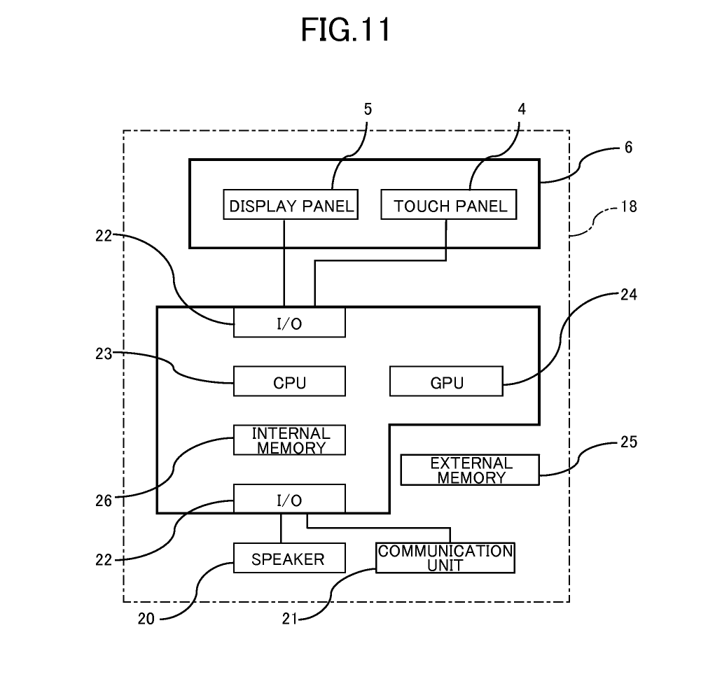

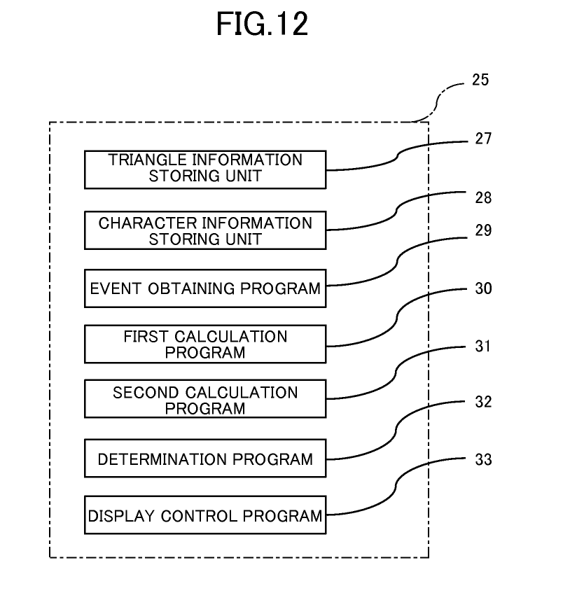

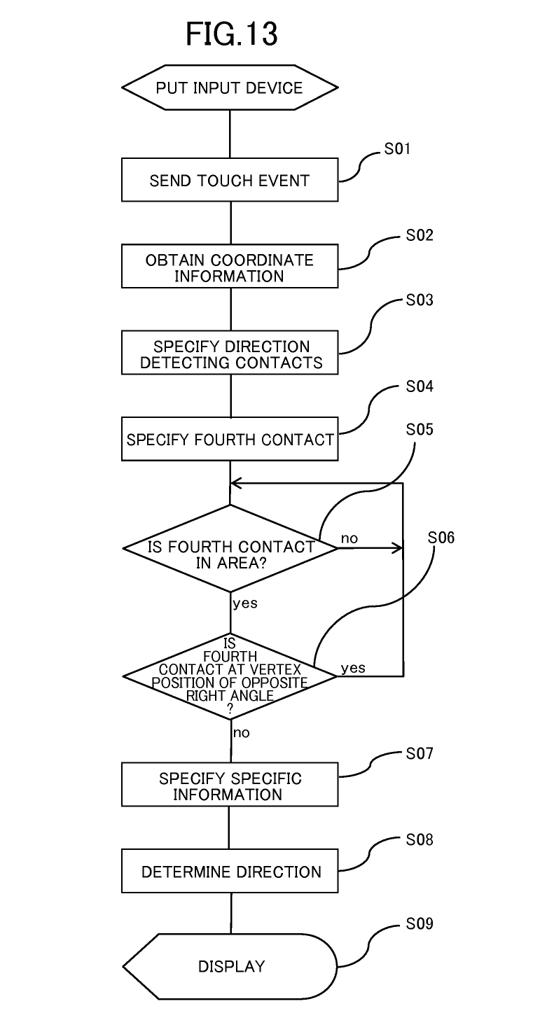

In FIGS. 10 and 11, numerals same as in FIGS. 1 to 9 indicate the same or corresponding parts, and a tablet terminal 18 including a panel module 6 on the surface formed by laminating a touch panel 4 and a display panel 5 is illustrated. The tablet terminal 18 includes a casing edge 19 for fixing the panel module 6. On the casing edge 19, a speaker 20, a communication unit 21 constituing wireless LAN (Local Area Network) such as WiFi (Wireless Fidelity), and an I/O (Input/Output) interface 22 for connecting to outside devices are attached. A CPU (Central Processing Unit) 23 controls the touch panel 4, the display panel 5, the speaker 20, the communication unit 21, and the I/O interface 22, for example. When the power is ON, an Operating System (OS) for the tablet terminal is executed under the control of the CPU 23, the display panel 5 displays an image through a GPU (Graphics Processing Unit) 24, and an embedded application and an installed application stored in an external memory 25 are executed through an internal memory 26. Further, when the capacitance is changed on the touch panel 4, the CPU 23 passes position coordinate information of the position on which the capacitance is changed to the OS as a touch event. Here, a power supply has been omitted. As shown in FIG. 12, the tablet terminal 18 according to this embodiment includes, in the external memory 25, a triangle information storing unit (first storing means) 27 for storing two sides defining a right-angled triangle of an input device 1 and a right angle between the two sides, and a character information storing unit (second storing means) 28 for storing character information of each hiragana in association with an information identifying contact 82 of each input device 1 shown in FIGS. 6 and FIG. 7. The tablet terminal 18 also has an area in which an event obtaining program (coordinate information obtaining means) 29 is installed. The event obtaining program is for obtaining, from the OS, a touch event including coordinate information of the direction detecting contacts 81 and the information identifying contacts 82 that touch the touch panel 4.

The CPU 23 executes calculation for specifying the direction detecting contacts 81 and the information identifying contacts 82 by calculating three vertexes of the triangle based on the coordinate information obtained from the event obtaining program 29, and controls the display panel 5 to display information that is extracted from the character information storing unit 28 and specific to the specified information identifying contacts 82.

As shown in FIG. 12, the external memory 25 further includes areas that respectively store the programs for executing the control mentioned above, such as, a first calculation program (first calculation means) 30, a second calculation program (second calculation means) 31, a determination program (determination means) 32, and a display control program (display control means) 33. The first calculation program 30 is a control program for extracting three vertexes of a triangle in order to calculate two sides of the triangle and an internal angle between the two sides based on the coordinate information obtained by executing the event obtaining program 29, and specifying direction detecting contacts 81 that form a predetermined triangle stored in the triangle information storing unit 27 based on the two sides and the internal angle. The second calculation program 31 is a control program for specifying, from the event obtaining program, coordinate information of the fourth contact, which is not at the three vertexes of the triangle. The determination program 32 determines whether the coordinate information of the specified fourth contact is positioned in the rectangular area defined by the two sides interposing the specified internal angle. The determination program 32 also determines whether the coordinate information of the specified fourth contact is coordinate information indicating the vertex position of the opposite angle to the specified internal angle. When the position indicated by the coordinate information of the specified fourth contact is positioned in the rectangular area, and the coordinate information of the specified fourth contact is not the coordinate information indicating the vertex position of the opposite angle, the determination program 32 specifies the coordinate information of the fourth contact as the coordinate information indicating the positions of the information identifying contacts 82. The display control program 33 is a control program for extracting information specific to the specified information identifying contact 82 from the character information storing unit 28, and displaying the information on the display panel.

Next, operations will be discussed.

As shown in FIG. 10, an input device 1 provided with hiragana character of “ [symbol] ” is placed on an arbitrary position on the panel module 6 of the tablet terminal 18. The input device 1 with the character “ [symbol] ” has the direction detecting contacts 81 and the information identifying contact 82 projecting from the bottom surface as shown in FIG. 2. When the capacitance is changed on the touch (proximate) position on the touch panel 4, the coordinate information of the position on the touch panel 4 where the capacitance is changed is passed to the OS as a touch event under the control of the CPU 23 (Step S01). The coordinate information of the touch event passed to the OS is obtained by the event obtaining program 29 (Step S02).

Next, based on the coordinate information obtained by the event obtaining program 29, the CPU 23 executes the first calculation program 30 to extract three vertexes of a triangle and calculate two sides of the triangle and an internal angle between the two sides. Then, based on the two sides and the internal angle, direction detecting contacts 81 forming a right-angled triangle stored in the triangle information storing unit 27 (predetermined triangle) are specified (Step S03). The second calculation program 31 to be executed subsequently specifies the coordinate information of the position other than the positions of the three vertexes of the triangle as the coordinate information of the fourth contact (Step S04). Subsequently, the determination program 32 determines whether at least one fourth contact indicated by the coordinate information specified in Step S04 is positioned in the rectangle area defined by the two sides interposing the right angle (internal angle) calculated in Step S03 (Step S05). If the fourth contact indicated by the coordinate information is positioned in the rectangle area, the determination program 32 determines whether the coordinate information indicates the vertex position of the opposite right angle to the right angle (internal angle) (Step S06). If the fourth contact indicated by the coordinate information is positioned in the rectangle area, and the coordinate information does not indicate the vertex position of the opposite right angle to the right angle, the determination program 32 specifies the coordinate information of the fourth contact as the coordinate information indicating the position of the information identifying contact 82.

The display control program 33 extracts information specific to a hiragana character corresponding to the information identifying contact 82 specified in Steps S05 and S06 from the character information storing unit 28, and specifies the information as information specific to the input device 1 (Step S07). Further, under the control of the CPU 23, the display control program 33 determines a direction of the specific information displayed on the display panel 5 based on the inclination of the calculated right-angled triangle to the touch panel 4 (Step S08), and displays the information on the display panel 5 at the position where the input device 1 is placed on the panel module 6 according to the direction of the input device 1 (Step S09).

In this embodiment, the program for displaying information specific to the input device 1 on the display panel 5 of the tablet terminal 18 is stored in the external memory 25 and executed on the OS for the tablet terminal so that the program is executed under the control of the CPU 23 of the tablet terminal 18. As such, the direction detecting contacts 81 and the information identifying contacts 82 of the input device 1 can be easily recognized, and the information specific to the input device 1 can be displayed according to the direction of the input device 1 placed on the display panel 5 of the panel module 6.

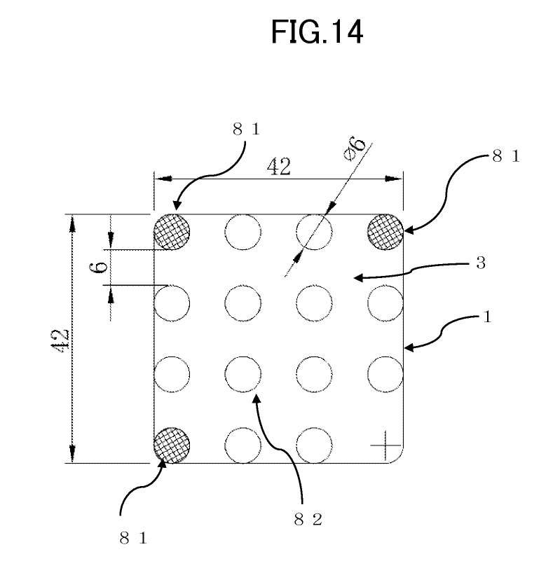

FIG. 14 illustrates particular dimensions of the input device 1 in this embodiment. The input device 1 is a cube of 42 mm per side, on which direction detecting contacts 81 and information identifying contacts 82 are placed adjacent to the periphery of the rectangular bottom surface in vertical and horizontal 4×4 regions. The direction detecting contacts 81 and the information identifying contact 82 are shaped as a cylinder having a diameter of 6 mm, and the adjacent direction detecting contact 81 and information identifying contact 82 are separated from each other by 6 mm. The bottom surface of the input device 1 may be a square of 20 mm to 80 mm per side, diameters of the direction detecting contact 81 and the information identifying contact 82 may be 5 mm or more, and the adjacent direction detecting contacts 81 and information identifying contacts 82 may preferably be separated from each other by 6 mm or more. This enables the touch panel to easily recognize a touch, and the input device 1 to be a size easily held in one hand of people, particularly children.

### INDUSTRIAL APPLICABILITY

An input device of the present invention can be used as input means for inputting information into a panel module having a touch panel and a display panel.

The invention claimed is:

1. An input device comprising:
a first, a second and a third direction detecting contact that are projecting portions to touch three positions on a touch panel and form a triangle having vertexes on the three positions;
at least one information identifying contact that touches the touch panel together with the three direction detecting contacts so that specific information to be displayed on a display panel is identified according to a placement position of the information identifying contact with respect to the triangle.

2. The input device according to claim 1, wherein
the information identifying contact is disposed in a rectangular area defined by two sides of the triangle, the two sides interposing an internal angle of a first vertex of the triangle.

3. The input device according to claim 2, wherein
the information identifying contact is disposed in the rectangular area other than a position of the internal angle and a position of a vertex of an angle opposite to the internal angle.

4. The input device according to claim 2, wherein
the triangle is a right-angled triangle, and the first vertex is a vertex of a right angle of the right-angled triangle.

5. The input device according to claim 1, wherein
a direction of the triangle formed by the direction detecting contacts determines a direction of the specific information to be displayed.

6. The input device according to claim 1, wherein
an area in which the direction detecting contacts and the information identifying contact are disposed is a substantially square area that has the three direction detecting contacts at respective corners, a length of a side of the square area being 20 mm to 80 mm.

7. The input device according to claim 6, wherein
a leg that does not react to a change in capacitance is further provided at a corner of the substantially square area, the corner being other than the corners at which the direction detecting contacts are disposed.

8. The input device according to claim 6, wherein
each of the direction detecting contacts and the information identifying contact is 5 mm or more in diameter, and
the direction detecting contacts and the information identifying contact are apart from one another by 6 mm or more.

9. The input device according to claim 1, wherein
each of the direction detecting contacts and the information identifying contact is selectively disposed in a region in a rectangular area formed in a grid pattern having four corners.

10. The input device according to claim 9, wherein
the information identifying contact is disposed in a region other than the region at each of the four corners.

11. A touch panel display system, comprising:
a panel module formed by laminating a touch panel and a display panel, the touch panel recognizing a detected touch position as coordinate information, and the display panel displaying an image on a screen;
an input device comprising:
a first, a second and a third direction detecting contact that are projecting portions to touch three positions on the touch panel and form a triangle having vertexes on the three positions, and
at least one information identifying contact that touches the touch panel together with the three direction detecting contacts so that specific information to be displayed on the display panel is identified according to a placement of the information identifying contact with respect to the triangle;
storing means for storing the specific information corresponding to a position of the information identifying contact with respect to the triangle;
coordinate information obtaining means for obtaining coordinate information of a contact that touches the touch panel;
calculation means for calculating three vertexes of the triangle based on the coordinate information obtained by the coordinate information obtaining means and specifying the direction detecting contacts and the information identifying contact; and
display control means for extracting, from the storing means, the specific information corresponding to the information identifying contact specified by the calculation means and displaying the specific information on the display panel.

12. The touch panel display system according to claim 11, wherein
in a case where coordinate information indicates that a fourth contact is positioned in a rectangular area defined by two sides interposing an internal angle of a first vertex of the triangle, the calculation means specifies the coordinate information of the fourth contact as the coordinate information of the information identifying contact.

13. The touch panel display system according to claim 11, wherein
the display control means controls a direction of the specific information displayed on the display panel based on an inclination of the triangle with respect to the touch panel, the triangle being calculated by the calculation means.

14. The touch panel display system according to claim 12, wherein
the triangle is a right-angled triangle, and the first vertex is a vertex of a right angle of the right-angled triangle.

15. A touch panel display system comprising:
a panel module formed by laminating a touch panel and a display panel, the touch panel recognizing a detected touch position as coordinate information, and the display panel displaying an image;
an input device comprising:
a first, a second and a third direction detecting contact that are projecting portions to touch three positions on the touch panel and form a triangle having vertexes on the three positions, and
at least one information identifying contact that touches the touch panel together with the three direction detecting contacts so that specific information to be displayed on the display panel is identified according to a placement of the information identifying contact with respect to the triangle;
first storing means for storing lengths of two sides and an internal angle between the two sides that define the triangle;
second storing means for storing the specific information corresponding to a position of the information identifying contact with respect to the triangle;
coordinate information obtaining means for obtaining coordinate information of a contact that touches the touch panel;
first calculation means for extracting three vertexes of the triangle based on the coordinate information obtained by the coordinate information obtaining means, calculating the two sides of the triangle and the internal angle between the two sides, and specifying, based on the two sides and the internal angle, the direction detecting contacts that form a predetermined triangle stored in the first storing means;
second calculation means for specifying, from the coordinate information obtaining means, coordinate information of a fourth contact that is disposed on a position other than the three vertexes of the triangle;
determination means for determining whether the coordinate information of the fourth contact specified by the second calculation means is positioned in a rectangular area defined by the two sides interposing the internal angle calculated by the first calculation means and whether the coordinate information of the fourth contact is coordinate information indicating a position of a vertex of an angle opposite to the internal angle and, in a case where the coordinate information of the fourth contact is positioned in the rectangular area and does not indicate the position of the vertex of the angle opposite to the internal angle, specifying the coordinate information of the fourth contact as coordinate information indicating the position of the information identifying contact; and
display control means for extracting, from the second storing means, the specific information corresponding to the information identifying contact specified by the determination means, and displaying the specific information on the display panel.
